(19) United States
(12) Patent Application Publication
(10) Pub. No.: US 2012/0013099 A1
(43) Pub. Date: Jan. 19, 2012

(54) COMBINATION OF A SHOE, A FRAME AND A PEDAL FOR RACING BICYCLES

(76) Inventor: Francesco Riondato, Bassano del Grappa (IT)

(21) Appl. No.: 13/138,113

(22) PCT Filed: Nov. 9, 2009
(86) PCT No.: PCT/EP2009/007990

§ 371 Date: Jul. 20, 2011

(30) Foreign Application Priority Data
Nov. 17, 2008 (IT) VI2008A000267

(51) Int. Cl. B62M 1/02

(52) U.S. Cl. 280/259

(57) ABSTRACT

A shoe for racing bicycles on the underlying sole of which a plate (8) is mounted fixed to the sole (4′) through screws (8′), the stems of which pass through slots (8″) made on the plate (8) and are screwed into threaded holes previously made on the sole (4′). The plate (8) has a longitudinal center-line axis (25) which is separated from the vertical plane (30) tangent to the outer end of the pedal crank corresponding to the shoe by a distance (23) which is 6-8 mm greater than the corresponding distance foreseen for a similar per se known type of shoe sole.

The present finding concerns a combination of a shoe, a frame and a pedal for racing bicycles which allows the propulsive forces of the lower limb to be evenly distributed on the vertical of the rotation axis of the pedal, according to the general part of claim 1.

Preliminarily, it should be noted that the present finding has been inspired by and represents the fruit of seven years of study carried out by the inventor in the field of Muscular Physiology and Joint Mechanics of the human body and has given rise, in particular, to the embodiments described in the international publications n. WO2004069636 and WO2006015731, concerning two saddles, for leisure bicycles and for racing bicycles, as well as the publication n. WO2006013063, concerning a support rail for said saddles.

For his studies of muscular and joint physiology of the locomotory apparatus of the human body, the inventor used the publication of the Volume “Fisiologia Articolare—ARTO INFERIORE” vol. II—Prof. I. A. Kapandji V Italian edition published by Bonduzzi Editore, year 2006—I.S.B.N.: 88-323-2747-3; thereafter, to support what is stated in the description and the claim, we shall quote some of the topics of said Volume, simply marked with “ref”. This Volume clearly and precisely illustrates the topic mentioned in the title, with abundant iconography, which comprises numerous examples and even mechanical models which can even be reproduced by a craftsman, without needing particular mechanical equipment.

With all this said, it is worth remembering that a bicycle, in per se known ways, is provided with pedals on which the cyclist pedals with his own feet, wearing footwear. Each of said pedals is hinged, at a horizontal axis, to the end of a pedal crank which, at the opposite end, is vice versa fixedly connected to a pin, in turn fixedly connected to one or more co-axial gear sprockets, the teeth of which are engaged with a motion transmission chain. The pedal cranks of said pedals are arranged parallel to one another on two opposite sides of the bicycle, in a diametrically opposite position from the gear sprocket.

The main purpose of the present finding is that of making a shoe, a frame and a pedal for racing bicycles, using which the cyclist is able to exploit all the propulsive forces of the lower limb, to carry out more comfortable pedalling, using his own physical abilities in the best way, with respect to what is currently possible to carry out with known types of shoes, frame and pedals for racing bicycles.

This is obtained, according to the finding, by configuring the shoe, frame and pedal for racing bicycles, without altering, however, the hooking and unhooking mechanisms of the aforementioned pedal, according to the characteristics foreseen in the characterizing part of claim 1.

These and other characteristics of the finding shall now be described in detail in the following description, referring to some of its preferred embodiments, given as an example and not for limiting purposes, with the help of the attached drawing tables, in which:

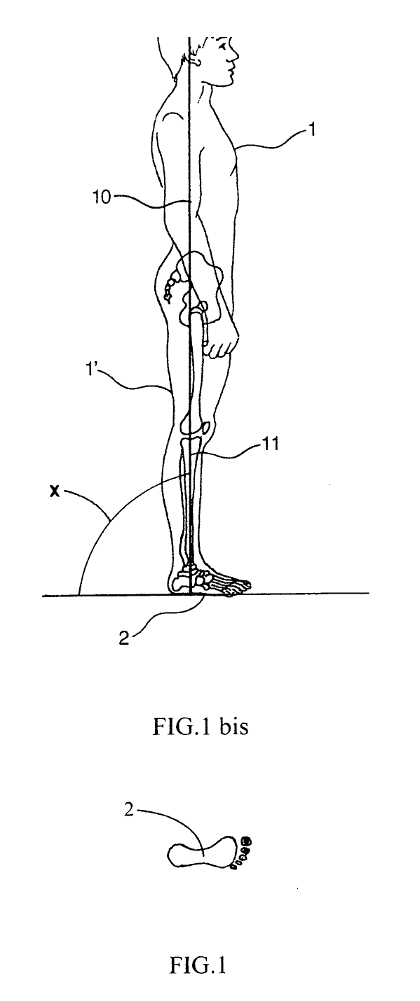

FIGS. 1 and 1 bis (table I) respectively represent the footprint of the human body and a man in a static vertical standing position, with the skeletal axis highlighted, that, at the leg, coincides with the mechanical axis;

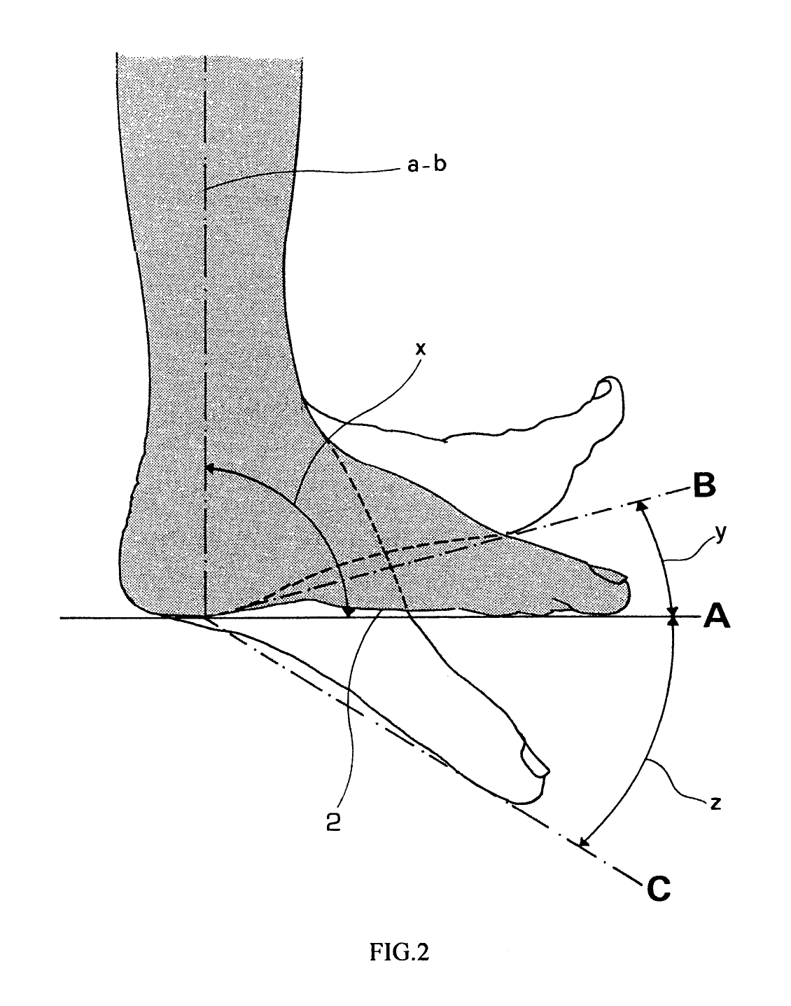

FIG. 2 (table II) represents a side view of the foot, in its normal, flexed and extended positions, respectively;

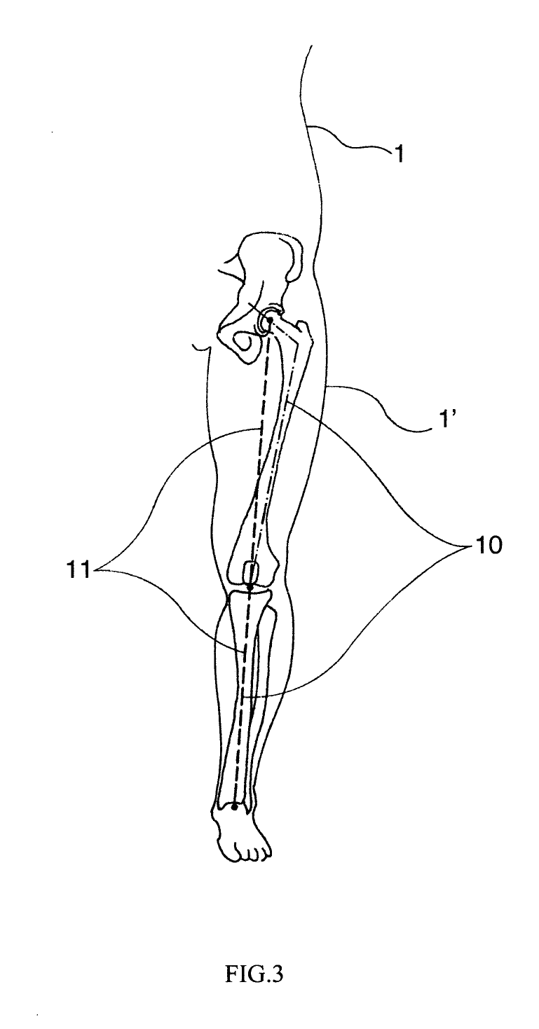

FIG. 3 (table III) represents the front plane of the lower limb, with the relative bones, the skeletal axis and the mechanical axis highlighted;

FIG. 4 (table IV) illustrates the side view of a cyclist sitting on the bicycle according to the finding, with the view of the sagittal plane of the joints of the hip, knee and ankle and the mechanical axis, in the action of final thrust of the lower limbs on the pedal;

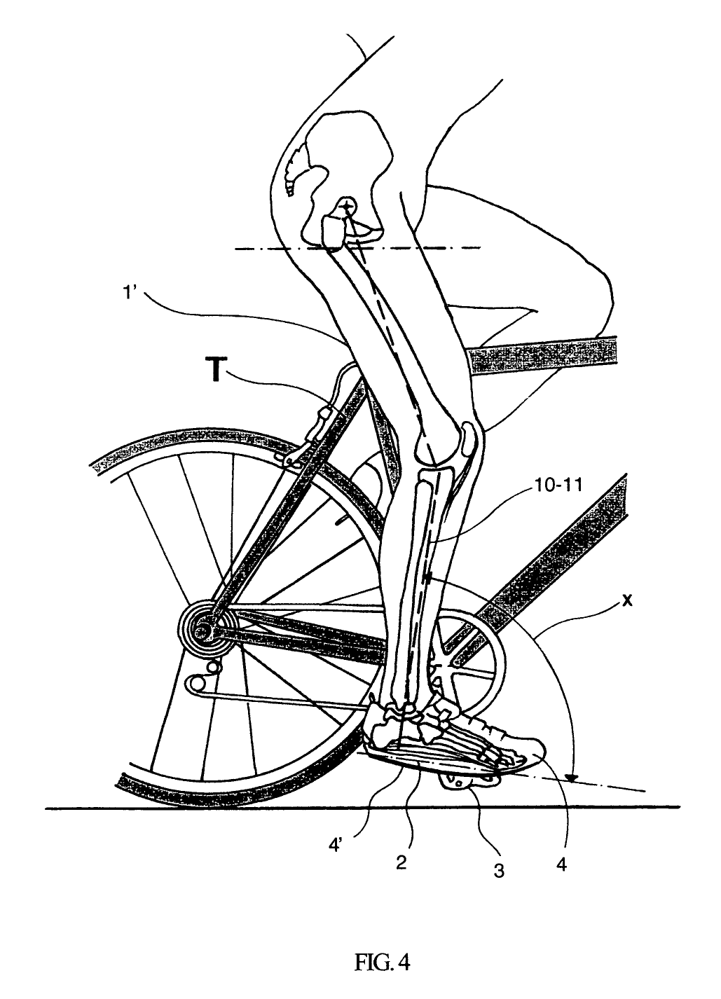

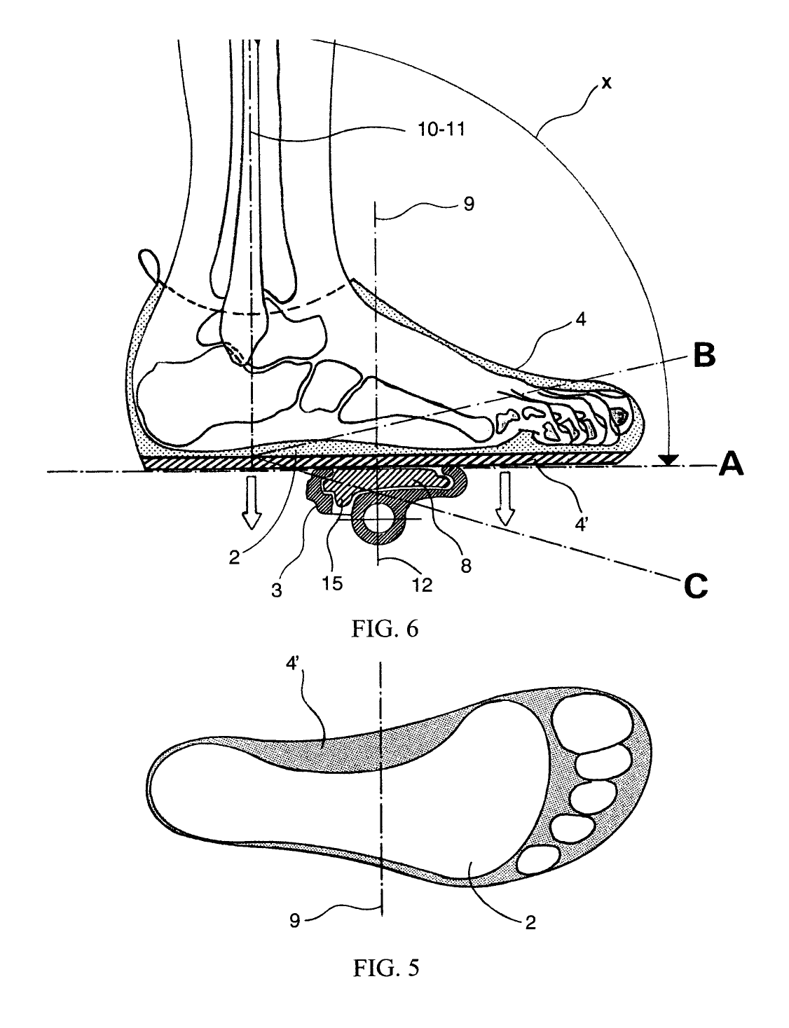

FIG. 5 (table V) represents the plan of the supporting surface of the foot and the sole of a shoe;

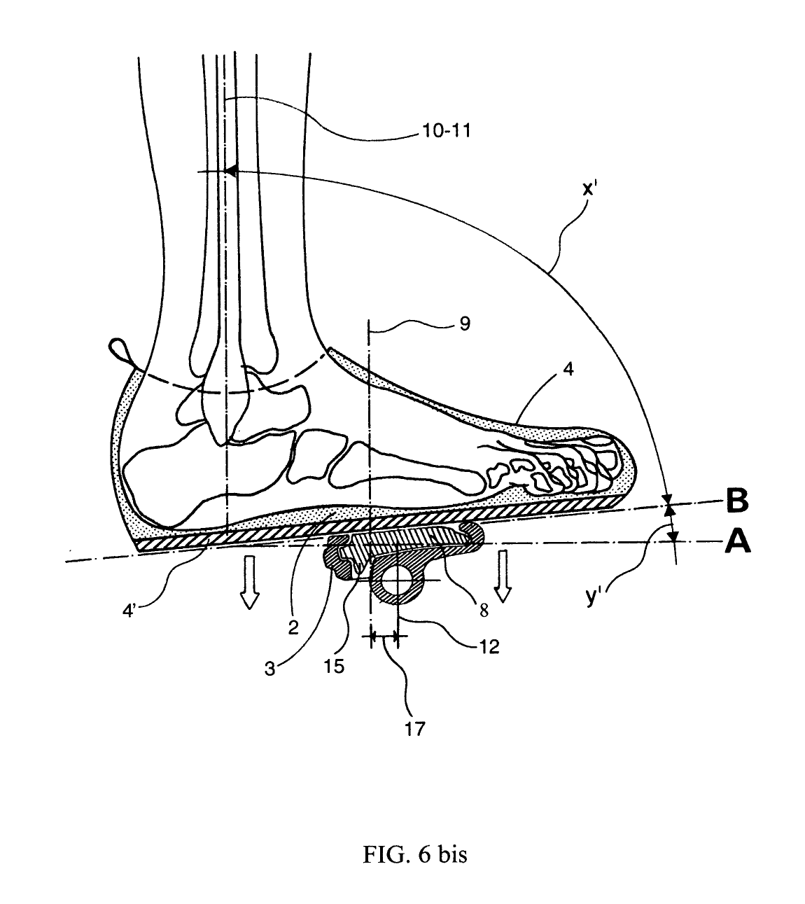

FIG. 6 (table V) illustrates the sagittal plane of the lower part of the leg and of the foot which is wearing the shoe seen in a vertical section, resting on a conventional type of racing pedal, seen in a vertical section, in a position of perfect balance, with the flexing and extension lines highlighted;

FIG. 6 bis (table VI) shows the sagittal plane and the vertical sections of what has been illustrated in the previous figure, in a slightly flexed condition;

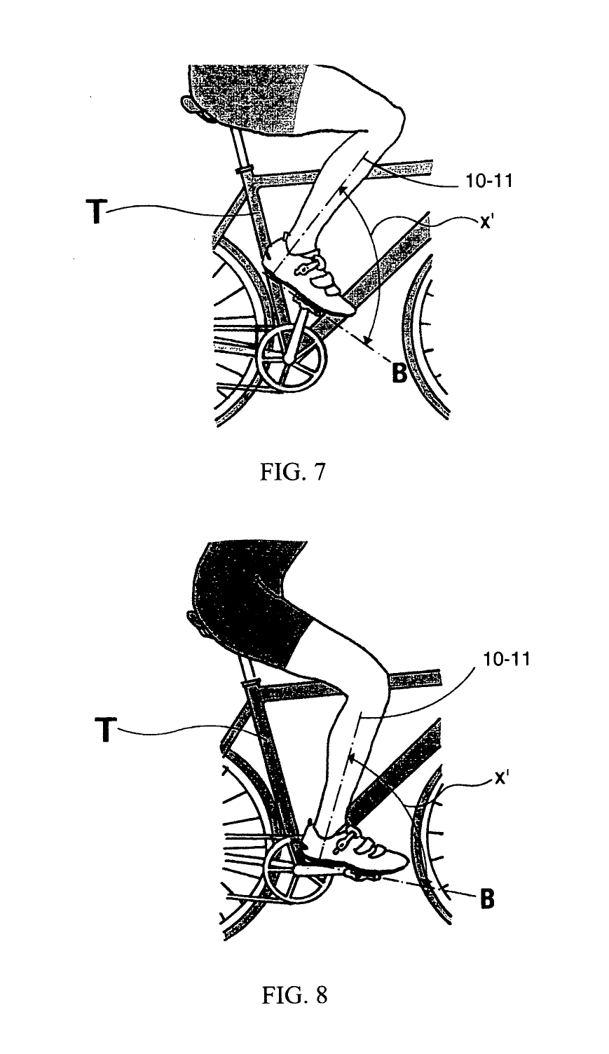

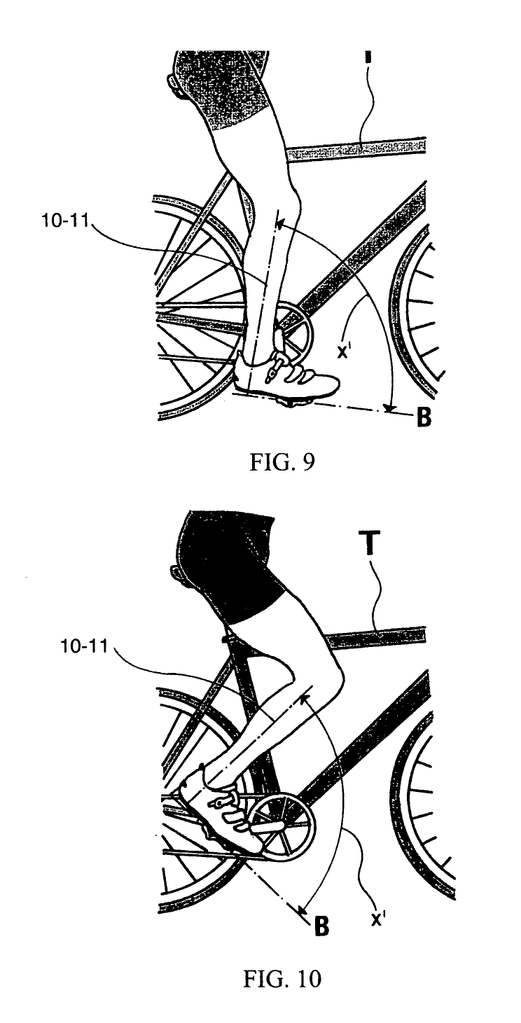

FIGS. 7-10 (tables VII-VIII) represent four side views of the lower limb of a cyclist while pedalling on the bicycle according to the finding, in four different steps in succession;

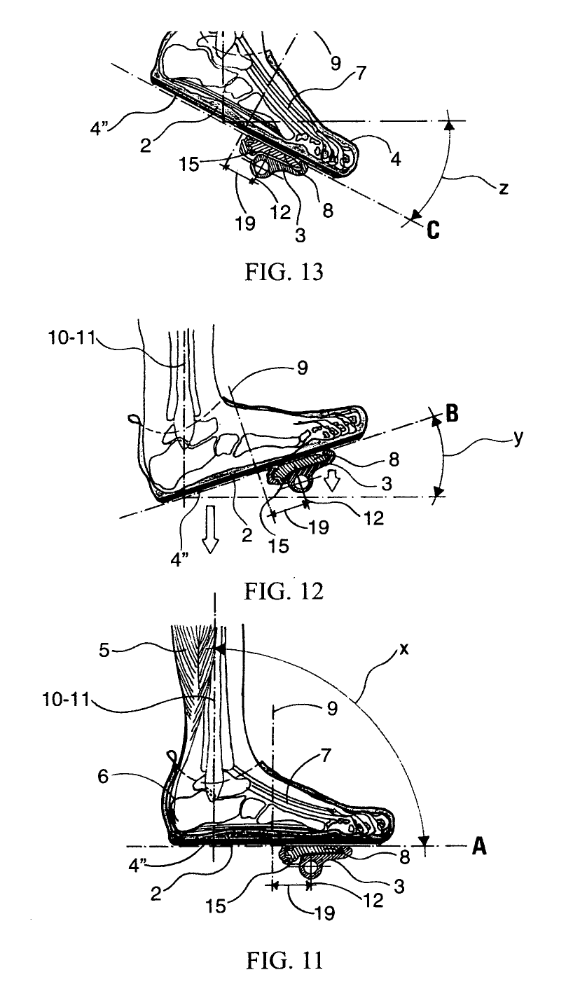

FIGS. 11-13 (table IX) illustrate the sagittal plane of the foot wearing a shoe seen in a vertical section, resting on the pedal, seen in a vertical section, of a conventional bicycle, in a normal posture and in the flexed and extended conditions, respectively;

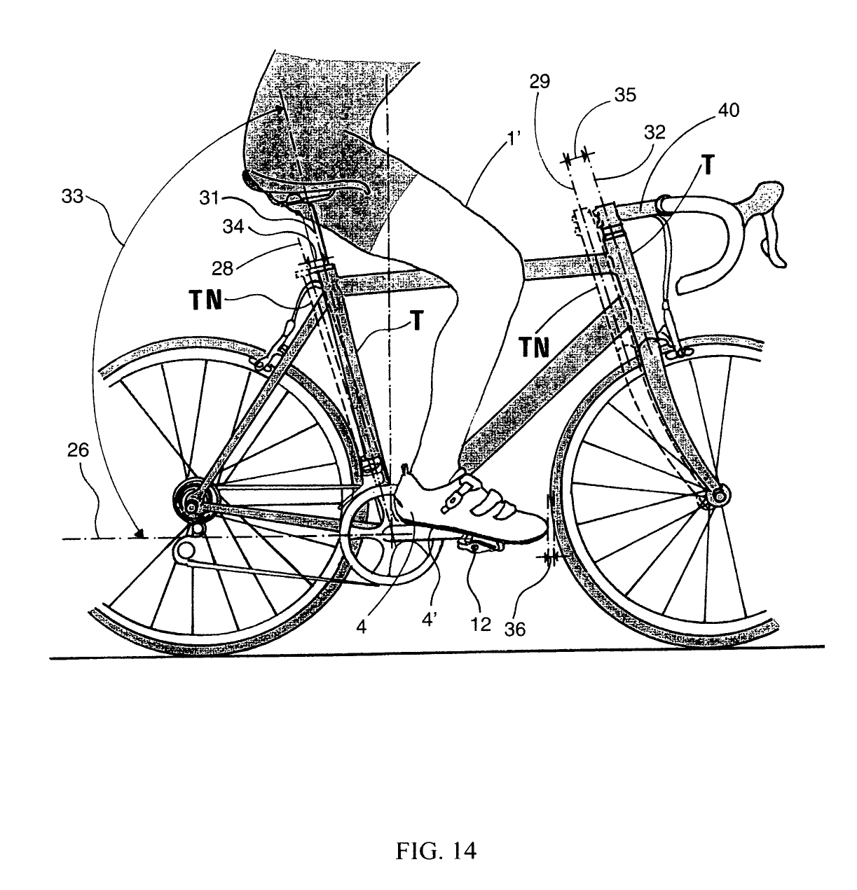

FIG. 14 (table X) represents a side view of a bicycle made according to the finding in which there is a cyclist with the axes of two tubular elements highlighted, suitably shifted with respect to those of a conventional type of bicycle;

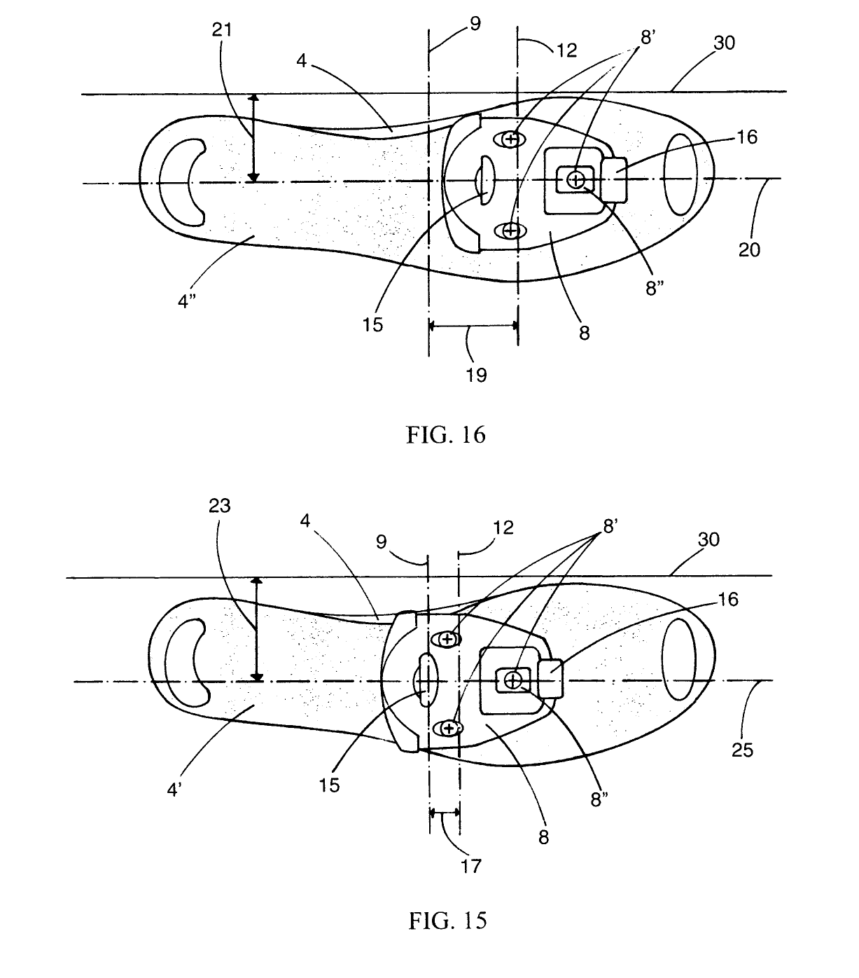

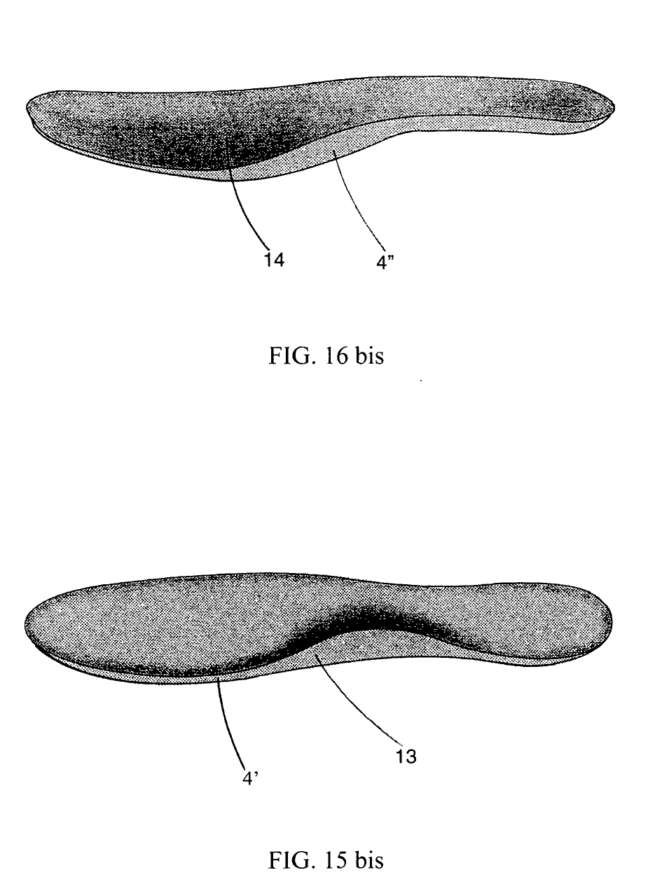

FIG. 15 (table XI) represents the plan of the sole of a shoe for racing bicycles made according to the finding;

FIG. 16 (table XI) represents the same view as the previous figure of the sole of a shoe for a conventional type of bicycle;

FIG. 15 bis (table XII) represents the perspective view of the inner part and the inner surface of the sole of the shoe according to FIG. 15;

FIG. 16 bis (table XII) represents the perspective view of the inner part and the inner surface of the sole of the shoe according to FIG. 16;

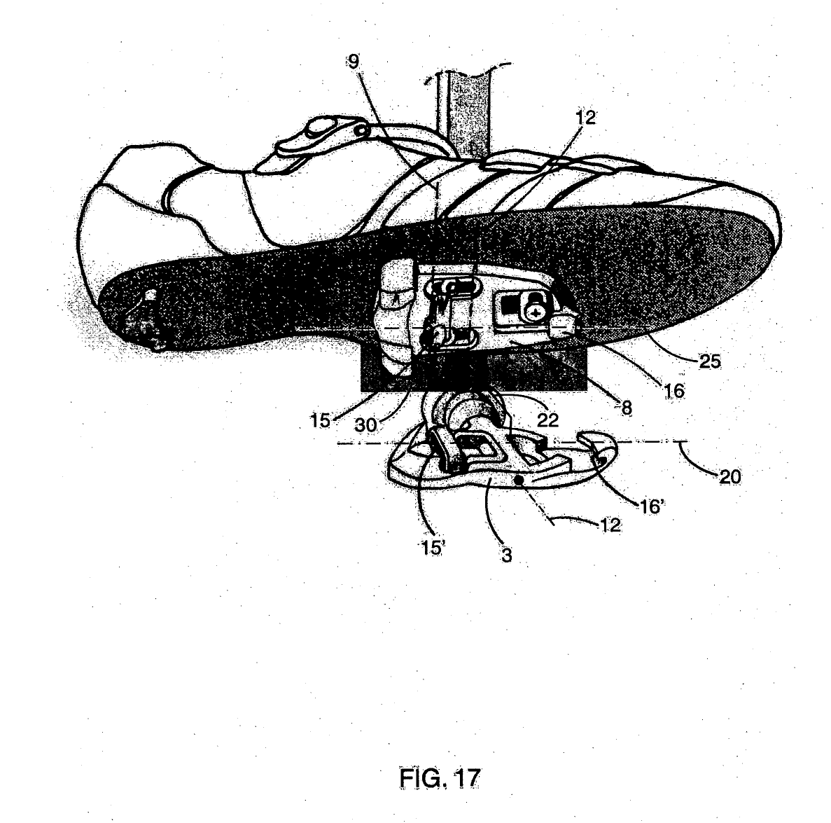

FIG. 17 (table XIII) represents a perspective view of the pedal for racing bicycles, according to the finding, equipped with a quick hooking and unhooking device, of the per se known type, highlighting the distance of the longitudinal centre-line axis of the device itself with respect to the outer vertical plane of the pedal crank and of the shoe to be hooked to the aforementioned pedal according to the finding.

In order to completely describe the assembly according to the finding we wish, in the rest of the description, to carry out a brief close examination of the Joint Mechanics and Muscular Physiology of the lower limb and in particular, of the supporting surface 2 of the foot, where the weight of the human body rests and where it converges with the muscular propulsive forces, when the lower limbs are set in motion.

In FIGS. 1 and 1 bis it can be seen that when a man (when this word is used hereafter, it does not indicate any actual difference between male and female and it means anyone belonging to the human species) is in a static vertical standing position, he transmits the force of the weight of his own body along the axis 10-11 of the trunk and of the lower limbs 1′ on the plan of the foot which rests on the ground with all of its supporting surface 2, which forms the footprint (ref. pag. 240, line 11 and FIG. 46 pag. 241) and half of the weight force is distributed on the rear part of the heel and the other half on the frontal area of the foot (ref. pag. 236, line 14 and FIG. 34 pag. 237).

With reference to FIG. 2, the normal position of the foot (A) occurs when the supporting surface 2 is perpendicular (angle X equal to 90°) to the axis 10-11 of the leg; from this position, when the back of the foot comes closer to the front face of the leg, there is the flexing movement (position B) of the ankle joint or otherwise there is an extension movement (position C) of said joint; in the ref., the normal position is clearly described, just as the flexing and extending movements are quoted as being of about 20° and 30°, respectively (ref. pag. 162, line 1 and illustrations pag. 163).

With reference to FIG. 3, the three joints of the hip, knee and ankle are aligned along the same line as the mechanical axis b that, at the level of the leg, lies over that of the skeleton (ref. pag. 76, line 7 and FIG. 3, pag. 77).

With reference now to FIG. 4, it can be seen that, when the cyclist uses the bicycle T as arranged according to the finding and sets the lower limb 1′ in motion, he rests the foot, wearing a shoe 4, on the pedal 3 in a normal position (A), and therefore according to the finding the supporting surface 2 always remains perpendicular to the mechanical and skeletal axes 10-11 of the leg (ref. pag. 76, line 7 and FIG. 3 pag. 77 and ref pag. 162, line 1 and FIG. 3 pag. 163). With reference to FIGS. 5 and 6, the above can be seen in a detailed manner; the transverse centre-line 9 of the supporting surface 2 and, of course of the sole 4′, of the shoe 4 is at the vertical of the rotation axis 12 of the pedal. In this position, since the muscular propulsive forces are half distributed on the rear part of the heel and the other half on the front part of the foot (see white arrows) and since the supporting surface 2 and consequently the sole 4′ of the shoe 4, are perpendicular to the axis 10-11 of the leg, these forces converge in the form of a concentrated load directly on the vertical of the rotation axis 12 of the pedal 3, which, by means of the pedal crank and of the remaining per se known parts of the bicycle, set the bicycle itself in motion and give it speed (ref. pag. 236, line 14 and FIG. 34 pag. 237).

With the foot protected by a shoe thus arranged on the pedal during this alternated pedalling action, the lower limb generates muscular propulsive thrust energy on the aforementioned pedal, which is fundamentally different from the typical action carried out while walking, running or jumping.

Indeed, when we run or jump, the foot comes into contact with the ground in four steps:
entering in contact with the ground through the heel;
maximum contact step, in which the foot is placed on the ground with the entirety of its footprint;
step in which the tensor muscles of the ankle keep the plan arch rigid to allow the foot to extend so as to provide the upward thrust;
contraction step of the tensor muscles of the toes, so that at the end of this step, the stored energy is returned (the succession of these steps is described in the ref. of pag. 240 and in the illustrations of pag. 241).

In FIGS. 5 and 6 we have illustrated how to distribute all the propulsive forces of the lower limb 1′ as a load concentrated on the vertical of the rotation axis 12 of the pedal, but the position of the shoe is arranged “as a balance” on the vertical of the axis 12; inevitably, during each alternated pedalling action, the foot tends to flex (B) or extend itself (C), stressing the joints of the heel and consequently the Achilles tendon.

With reference to FIG. 6 bis, the correct position of the shoe 4 on the pedal 3, according to the finding, can be seen.

The supporting surface 2 of the foot and consequently of the sole 4′ of the shoe 4, is arranged on the pedal 3, with the transverse centre-line axis 9 in a position set back with respect to the vertical of the rotation axis 12 of the pedal, by a distance 17 equal to about 15-25 mm. Consequently, the loads deriving from the muscular propulsive thrust of the lower limb 1′ are arranged to a slightly greater extent at the heel with respect to the frontal area of the foot. There is thus a balanced position in which a slight flexing position is determined (condition B of the foot, with the forming of an acute angle y′ up to about 5° with respect to the resting horizontal axis on the pedal) and consequently an angle x′ is formed of about 85° with respect to the axis 10-11 of the leg. In this way, as illustrated in FIGS. 7 to 10, the foot is kept in a slightly flexed condition (B) during all the pedalling actions, thus without stressing the joints of the ankle and of the Achilles tendon (ref. pag. 162 and fig. pag. 163). Of course it is necessary to arrange means suitable for determining the position of the foot with respect to the rotation axis 12 of the pedal, in a so-called “automatic” manner, in the way described above.

For this purpose it is worth remembering that while leisure bicycles can be used with any type of normal footwear, for racing bicycles the use of per se known pedals is foreseen which are equipped with a quick hooking and unhooking mechanism, but which require the use of special footwear (also per se known), which are also equipped with corresponding hooking and unhooking means which are compatible with the aforementioned pedals.

As can be seen in FIG. 16 the shoe worn by the cyclist using a conventional racing bicycle has a plate 8, made from plastic material, so as to hook the shoe 4 to the pedal 3, fixed through screws 8′, the stems of which pass through three slots 8″ existing on the plate and which are screwed into as many threaded holes previously made on the sole of the shoe; the longitudinal centre-line axis of the plate 8 coincides with a longitudinal reference axis 20 adopted by all the manufacturers of these particular shoes, which is separated from the vertical plane 30, tangent to the outer end of the pedal crank corresponding to the shoe, by an amount 21 equal to about 50-53 mm. Two connectors 15 and 16 protrude from the plate and are suitable for rapidly hooking into corresponding seats 15′ and 16′ (FIG. 17) present on the pedal of racing bicycles, all this in per se known ways. In practice, by observing the position of the plate 8 (in FIG. 16), once hooking has occurred on the pedal, the transverse centre-line axis 9 of the sole 4′ is in a set back position with respect to the projection on the plate of the vertical of the rotation axis 12 of the pedal 3, by an amount 19 equal to about 35-55 mm, to allow the cyclist to pedal with the front part of the supporting surface 2 of the foot. Vice versa, according to the finding, the same sports shoe is foreseen and, by observing in FIG. 15 the positioning of the plate 8, once the hooking has occurred on the pedal 3, the transverse centre-line 9 of the sole 4′ is set back by a distance 17 of 15-25 mm with respect to the projection on the plate 8 of the rotation axis 12 of the pedal, to allow the entire supporting surface 2 of the foot (FIG. 6 bis) to push down on the pedal.

The position of the plate 8, according to the finding, is slightly shifted outwards with respect to the pedal crank; indeed said plate, moving back towards the centre-line axis 9, is at the centre of the sole 4′ in the area in which it begins to narrow and the longitudinal centre-line axis 25 of said plate 8 is separated by an amount 23 equal to 56-60 mm from the vertical plane 30 tangent to the outer end of the pedal crank.

This difference means that the pedal 3, according to the finding, whilst still keeping the per se known hooking and unhooking mechanism of the plate 8, has the longitudinal centre-line axis of the hooking and unhooking mechanism (FIG. 17), where this is fixed and rotates on it, longer by an amount 22 equal to about 56-60 mm with respect to the length of the same longitudinal axis of a conventional pedal, so that the shoe 4 remains equally separated from the plane 30 of the pedal crank, as occurs on the conventional pedal.

Moreover, advantageously, the two soles also have an inner resting surface of the supporting surface 2 of the foot; in particular:
in FIG. 16 bis it can be seen that the inner surface of the sole 4″ of the shoe worn to use a conventional bicycle, has the front part 14 slightly curved downwards and the resting part of the heel higher up, so as to receive the front part of the supporting surface 2 of the foot, as if the athlete were walking, so as to say, on tiptoes; the sole configured in this way makes it possible for the muscular propulsive force of the lower limbs to be concentrated only on its front part;
in FIG. 15 bis it can be seen that the inner surface of the sole 4′ is substantially flat and slightly modelled to evenly receive the supporting surface 2; a slight rise is also present in the inner part 13 shaped like a bump or arch support which is in the area of arching of the foot to support the inner arch of the foot during the muscular propulsive thrust of the lower limb; this is reinforced at the centre-line and along the longitudinal axis, in particular from the plate to the heel area, to avoid possible yielding of the structure and to always obtain a horizontal support plane.

In order to understand the advantages of the present finding, we shall now illustrate how the different resting position of the foot on the pedal of a conventional racing bicycle causes there to be a lower capability of propulsive thrust of the lower limb, with respect to when the device according to the finding is used.

Indeed in a conventional bicycle (FIG. 11) the supporting surface of the foot 2 and the rigid sole 4′ of the footwear 4 rest on the pedal 3 with their front part and their transverse centre-line axis 9 is set back by a distance 19 of about 35-55 mm with respect to the projection on the plate of the vertical of the rotation axis 12 of the pedal 3.

As can be seen in FIG. 12, the loads of the muscular propulsive forces are arranged more on the rear area of the heel and less on the frontal area of the foot, in this way causing substantial flexing (B) of the latter up until, during the strain of alternated pedalling, in particular by racing cyclists, extensions even of an angle (y) of about 20° are reached (ref. a pag. 162 and to fig. pag. 163). Vice versa, when the cyclist moves on the saddle so as to arrange his pelvis on the rear part of the saddle, so as to obtain more powerful pedalling (FIG. 13), he terminates the thrust by contracting the muscles 7 of the foot, which is thus arranged in the position of maximum extension (C), with an angle of about 30° (we would like to point out that the inventor has taken this information from photographs taken during cycling competitions, which can be easily found in all specialized cycling magazines).

Thus, in order to avoid (FIG. 11) the foot flexing (B) and extending (C) and to keep the supporting surface 2 perpendicular to the axis of the leg 10-11, thanks also to the presence of the rigid sole 4″, the cyclist contracts the muscles of the leg 5, of the foot 7 and the Achilles tendon 6, which always remains tense; these two muscles and the Achilles tendon thus strictly participate with the muscles of the buttocks, of the hip and of the thigh in the forward muscular thrust of the lower limb 1′ and it is clear that in this condition of low muscular balance the propulsive thrust is lower, whereas the physical effort of the cyclist increases, particularly when going uphill. In order to allow an easy use of the pedal 3 according to the finding, for the leisure or racing bicycle, it is advantageous to foresee modifications on the frame with respect to what is normally foreseen in known bicycles. Moreover, it should be considered that the frame of the bicycle, for both leisure and racing bicycles, apart from having clear differences from an aesthetic point of view, structurally has a substantially standardized configuration whatever the “sizes” of the bicycle itself and, that is to say, regardless of whether the bicycle is intended for an adult, a child, etc. In order to allow an optimal use of the pedals according to the innovative positioning of the footwear according to the finding, the bicycle advantageously has a first variant due to the fact that the upper end of the axis of the tube 31 of the bicycle T according to the finding (FIG. 14), where the seat post is inserted, is further forward by a distance 34 equal to about 35-55 mm with respect to the corresponding end of the axis 28 of the tube of a per se known bicycle TN; therefore, the angle 33, formed between the axis 31 and the axis 26 arranged horizontally passing through the pedal movement axis, varies from 74° to 78°. Analogously the axis 32 of the tube of the bicycle T according to the finding, at the upper end of which there is the seat post to which the handle bar is fixedly connected and that vice versa, at its lower end, is fixedly connected to the fork of the front wheel, all of which, in per se known ways, whilst substantially maintaining the same inclination present in a bicycle of the known type, is moved forward by a distance 35 equal to about 35-55 mm with respect to the axis 29 of the corresponding tube of a conventional bicycle TN. In any case it shall be ensured that, as usual, the toe of the shoe, when the pedal crank is in the horizontal position, is separated from the wheel by a distance 36 equal to about 10-20 mm, to avoid the cyclist having problems when manoeuvring the handle bar to the right or to the left.

In practice, the exact forward position of the axis of the tube 32 shall depend on the size of the user and on the shoe he is wearing, said advanced forward position being easily compensated through a corresponding lengthening or shortening of the monoblock 40 on which the handle bar is fixed.

Tests carried out have verified that by using the footwear according to the finding, with all of it various provisions, the supporting surface of the foot is arranged in such a way with respect to the sole 4′ of the shoe 4 so as to create maximum contact of the supporting surface 2 on the sole itself; in this way the loads from the propulsive muscular thrust of the lower limb, both at the beginning of the alternated pedalling action, as well as when the cyclist rises to his feet to carry out a change of speed or to start a difficult uphill slope, spread out in a substantially even way over the entire surface of the sole 4′, to then discharge all their power as a concentrated load on the rotation axis 12 of the pedal.

In particular, numerous tests with professional cyclists and amateur cyclists have made it possible to verify that any individual cyclist is able to obtain better results with the same effort, with consequent ease in obtaining competitive results or in any case satisfaction in training; whereas in the case in which one does not wish to race competitively, but wishes to use the bicycle as simple means of transport, the user can follow his daily routes with less physical effort.

1. COMBINATION OF A SHOE, FRAME AND PEDAL FOR RACING BICYCLES (WHICH MAKE IT POSSIBLE FOR THE PROPULSIVE FORCES OF THE LOWER LIMBS TO BE EVENLY DISTRIBUTED ON THE VERTICAL OF THE ROTATION AXIS OF THE PEDAL), the bicycle being provided, in per se known ways, with two pedals, on each of which the cyclist pedals with his feet, each of said pedals being hinged, at a horizontal axis, to the end of a pedal crank, which, at its opposite end, is fixedly connected to a pin, in turn fixedly connected to one or more gear sprockets, on which the chain for transmitting motion is engaged, the pedal cranks of said pedals are arranged in a reciprocally parallel way on two opposite sides of the bicycle and in diametrically opposite positions on the gear sprocket, with it also being anticipated, again in per se known ways, that the cyclist wears shoes the underlying sole of which (4′) is fixed to a plate (8), made from per se known plastic material, the combination, according to the finding, being characterized in that the plate is arranged in such a way that the projection on to it of the rotation axis (12) of the pedal (3) is equal to a distance (17) of around 15-25 mm from the transverse centre-line axis (9) of the sole (4′), on which the plate (8) is fixed through screws (8′), the stems of which pass through three slots (8″) made on the plate and are screwed into threaded holes previously made on said sole (4′), the plate being designed so that its longitudinal centre-line axis (25), laying over the longitudinal centre-line axis of the sole (4′), is separated from the vertical plane (30) tangent to the outer end of the corresponding pedal crank to the shoe by a distance (23) equal to 56-60 mm, which is about 6-10 mm greater than the corresponding measurement (21) of the longitudinal axis (20) of a sole (4″) of a similar per se known type of shoe, said plate having at least two connectors (15, 16) projecting from it with the longitudinal centre-line axis laying over the axis (25) of the plate (8) suitable for rapidly hooking into corresponding seats (15′, 16′) arranged on the pedal (3) and on the corresponding longitudinal centre-line axis (25′) of the same, being foreseen that, once the plate (4′) is hooked onto the pedal (3), their longitudinal axes (25) and (25′) which lie over one another, are separated from the vertical plane (30) tangent to the outer end of the pedal crank by a distance (22) equal to 56-60 mm, about 6-10 mm greater than that of the hooking and unhooking mechanism of a per se known pedal, the frame having the upper end of the tube axis (31), on which the seat post is fitted, which is further forward by a distance (34) of about 35-55 mm, with respect to the position of the corresponding axis (28) of the tube present in a conventional frame, forming an angle (33) of 74°-78° between said axis (31) of the tube of the bicycle and the horizontal axis (26) passing through the rotation axis of the pedal crank, whereas the axis (32) of the tube which supports the seat post, that is in turn fixedly connected to the handle bar of the bicycle, is in a position which is further forward by a distance (35) equal to around 35-55 mm with respect to the axis (29) of an analogous tube present in a per se known type of bicycle, with it in any case being foreseen that the toe of the shoe, when the pedal crank is in the horizontal position, is separated from the wheel by a distance (36) equal to 10-20 mm, said advanced position being able to be compensated through a corresponding variation of length of the monoblock (40) on which the handle bar is fixed.

2. SHOE, belonging to the combination according to claim 1, characterized in that the sole (4′) is substantially flat for most of its extension, with a slight rise, on its inner side (13) shaped like a bump, at the arching of the foot, to support the inner arch of the aforementioned foot during the muscular propulsive thrust of the lower limbs, said inner surface of the sole being reinforced at its centre-line, said sole (4′) having a thickness such as to allow, in per se known ways, the nuts for screwing the screws (8′) to be housed inside it.

3. FRAME FOR RACING BICYCLE, belonging to the combination according to claim 1, characterized in that it has the upper end of the axis of the tube (31), onto which the seat post is fitted, which is further forward by a distance (34) of about 35-55 mm with respect to the position of the corresponding axis (28) of the tube present in a conventional type of frame, forming an angle (33) of 74°-78° between said axis (31) of the tube of the bicycle and the horizontal axis (26) passing through the rotation axis of the pedal crank, whereas the axis (32) of the tube which supports the post, which in turn is fixedly connected to the handle bar of the bicycle, is in a position that is further forward by a distance (35) equal to about 35-55 mm with respect to the axis (29) of an analogous tube present in a per se known type of bicycle, with it being in any case foreseen that the toe of the shoe, when the pedal crank is in the horizontal position, is separated from the wheel by a distance (36) equal to 10-20 mm, said advanced position being able to be compensated through a corresponding variation in length of the monoblock (40) onto which the handle bar is fixed.

4. SHOE TO BE USED ON A RACING BICYCLE, belonging to the combination according to claim 1, characterized in that its underlying sole (4′) is fixed to a plate (8), made from a per se known plastic material, arranged with the projection on to it (12) of the rotation axis of the pedal (3), which is separated by a distance (17) equal to about 15-25 mm from the transverse centre-line axis (9) of the sole (4′) on which the plate (8) is fixed with screws (8′), the stems of which pass through three slots (8″) made on the plate and screw into threaded holes previously made on said sole (4′), the plate being arranged so that its longitudinal centre-line axis (25), laying over the longitudinal centre-line axis of the sole (4′), is separated from the vertical plane (30) tangent to the outer end of the pedal crank corresponding to the shoe by a distance (23) equal to 56-60 mm, about 6-10 mm greater with respect to the corresponding distance (21) of the longitudinal axis (20) of a sole (4″) for a similar per se known type of shoe, said plate having at least two connectors (15, 16) projecting from it with longitudinal centre-line axis laying over the axis (25) of the plate (8) suitable for rapidly hooking into corresponding seats (15′, 16′) arranged on the pedal (3) and on its corresponding longitudinal centre-line axis (25′), with it being foreseen that, once the plate (4′) is hooked onto the pedal (3), their longitudinal centre-line axes (25), (25′) which lie over one another are separated from the vertical plane (30) tangent to the outer end of the pedal crank by a distance (22) equal to 56-60 mm, about 6-10 mm greater than that of the longitudinal centre-line axis of the plate and of a per se known pedal.

5. PEDAL, belonging to the combination according to claim 1, characterized in that the seats (15′, 16′) arranged on the pedal (3) suitable for hooking to and unhooking from the connectors (15, 16) of the plate (8), have their longitudinal centre-line axis laying over that of the pedal itself, which is separated from the vertical plane (30) tangent to the outer end of the pedal crank by a distance (22) equal to 56-60 mm, which is 6-10 mm greater with respect to the longitudinal centre-line axis of a per se known pedal.
On behalf of:
